(19) United States
(12) Patent Application Publication
(10) Pub. No.: US 2026/0260005 A1
(43) Pub. Date: Sep. 3, 2026

(54) IDENTIFICATION OF SYNTHETIC MEDIA AND DETERMINATION OF PERSON OF INTEREST PERMISSIBLE USE STATUS IN THE SYNTHETIC MEDIA

(71) Applicant: SRI International, Menlo Park, CA (US)

(72) Inventors: MD Hafizur Rahman, Santa Clara, CA (US); Martin Graciarena, Belmont, CA (US); Ewald Enzinger, Beaverton, OR (US); Lawrence Lee, Palo Alto, CA (US); Ronald Krakower, South Orange, NJ (US)

(21) Appl. No.: 19/468,567

(22) Filed: Feb. 3, 2026

Related U.S. Application Data
(60) Provisional application No. 63/753,280, filed on Feb. 3, 2025.

(51) Int. Cl. G06F 21/62; G06F 40/30; G06V 20/00; G06V 40/16; G10L 15/26; G10L 17/02; G06V 10/764

(52) U.S. Cl. CPC G06F 21/6209; G06F 40/30; G06V 20/95; G06V 40/172; G10L 15/26; G10L 17/02; G06V 10/764; G06V 2201/09

(57) ABSTRACT

Techniques for synthetic media detection and use verification are described. A computing system receives media content containing a representation of a person of interest. The system analyzes the media to determine if the representation of the person of interest comprises synthetic media. Upon confirming the presence of synthetic media, the system identifies content elements within the media, such as keywords transcribed from audio portions or visual objects detected in visual portions. The system compares the at least one content element to usage parameters that characterize authorized uses of the person of interest in media to determine a permissible use status. The system outputs an indication of the permissible use status.

This application claims the benefit of U.S. Patent Application 63/753,280, filed Feb. 3, 2025, which is incorporated by reference herein in its entirety.

### TECHNICAL FIELD

This disclosure is related to synthetic media detection.

### BACKGROUND

Artificial intelligence (AI) and machine learning (ML) technologies enable computer systems to perform tasks such as visual perception, speech recognition, and decision-making. Advancements in generative AI facilitate creation of synthetic media, often referred to as deepfakes. Deepfake technology utilizes deep learning algorithms to manipulate or generate visual and audio content. Generative adversarial networks and other neural network architectures allow for synthesis of realistic images, videos, and audio recordings that mimic the appearance and voice of real individuals. These technologies process data to learn patterns and characteristics associated with a specific subject, enabling generation of new content resembling the subject.

Media analysis systems employ various techniques to process and interpret digital content. Computer vision algorithms analyze visual data to identify objects, faces, and scenes within images or video frames. Facial recognition technology maps facial features from a visual input and compares the features to stored data to verify identity. Speaker recognition systems analyze audio signals to identify or verify a speaker based on voice characteristics. Automated speech recognition converts spoken language into text. These technologies function by extracting features from media files and applying classification models to determine content or identity.

Digital media platforms and social networks facilitate distribution of content. Content creators and entities utilize digital likenesses for purposes including, but not limited to, entertainment, advertising, and communication. Content identification systems monitor online platforms to track usage of specific media assets. These systems may utilize watermarking, fingerprinting, or metadata analysis to associate content with specific owners or sources. ML models assist in categorizing media based on visual or audio attributes.

### SUMMARY

This disclosure describes techniques for identifying synthetic media associated with a person of interest (POI) and determining a permissible use status of the synthetic media with respect to the POI. In some example aspects, a synthetic media analyzer scans social media platforms and online spaces to identify and obtain media content associated with the POI. A POI filter module isolates content relevant to the POI by utilizing face recognition and spoken speaker recognition algorithms to filter non-relevant data from the media content. Following isolation, a synthetic media and explanation module analyzes the media content to classify the media content as real or synthetic. In some examples, the synthetic media and explanation module outputs a probability metric indicating a likelihood that the media content is synthetic. Upon classifying media content as synthetic, or upon determining that the probability metric satisfies a threshold for suspicious content, a permissible use verification module initiates a verification process to determine whether the synthetic media content adheres to authorized or permissible use parameters defined for the POI. The verification process may include human review for content flagged as suspicious or synthetic..

In some examples, the verification process employs multi-modal analysis to validate compliance of the synthetic media with usage parameters that characterize permissible uses of synthetic media associated with the POI. An automatic speech recognition component of the disclosed system converts audio within the media into structured text to extract key phrases. A keyword filtering subsystem compares the extracted key phrases against a database of authorized terms permissible under the usage parameters. A visual object detection component of the disclosed system identifies visual elements, such as logos, products, or landmarks, and cross-references the visual elements with usage parameters included in an authorized object database. In some examples, to further enhance verification, the disclosed system may utilize Large Language Models (LLMs) or Retrieval-Augmented Generation (RAG) to compare the media content against a semantic profile or dossier of the POI. This semantic analysis aids in determining whether the context of the synthetic media aligns with the established persona or contractual permissions. The disclosed system may output one or more results of the above analysis, which may include compiling the results into a detailed report outlining compliance or identifying violations, such as unauthorized speech or unapproved visual associations of the POI and other personas, entities, brands, ideas, etc.

In addition to the above technical advantages, the techniques may provide one or more other technical advantages that realize at least one practical application. As discussed below, the disclosed system provides an automated and multi-modal synthetic media analysis system that applies a novel scheme for identifying synthetic media associated with a POI and characterizing the use of imagery, audio, or other uses of the POI in representation in the synthetic media. By comparing these characterizations with usage parameters that characterize permissible uses of the POI in media, the techniques enhances protection for a POI against unauthorized synthetic media (e.g., deepfake) usage. Validating content against authorized databases with the disclosed system and techniques thus facilitates compliance with permissible use cases, better control over misuse of synthetic media, prevention of commercial exploitation , and prevention of journalistic misinformation.

In one example, this disclosure is directed to a method for synthetic media detection and use verification, the method comprising: receiving media content comprising a representation of a person of interest; determining that the representation of the person of interest comprises synthetic media; identifying at least one content element within the media content, wherein the at least one content element includes at least one of: a keyword transcribed from an audio portion of the media content or a visual object detected in a visual portion of the media content; determining a permissible use status of the media content based on a comparison of the at least one content element to usage parameters that characterize authorized uses of the person of interest in media; and output an indication of the permissible use status.

In another example, this disclosure describes a computing system for synthetic media detection and use verification, the computing system comprising: at least one memory; and processing circuitry in communication with the at least one memory, the processing circuitry configured to: receive media content comprising a representation of a person of interest; determine that the representation of the person of interest comprises synthetic media; identify at least one content element within the media content, wherein the at least one content element includes at least one of: a keyword transcribed from an audio portion of the media content or a visual object detected in a visual portion of the media content; determine a permissible use status of the media content based on a comparison of the at least one content element to usage parameters that characterize authorized uses of the person of interest in media; and output an indication of the permissible use status.

In yet another example, this disclosure describes non-transitory computer-readable medium storing instructions that, when executed by processing circuitry, cause the processing circuitry to: receive media content comprising a representation of a person of interest; determine that the representation of the person of interest comprises synthetic media; identify at least one content element within the media content, wherein the at least one content element includes at least one of: a keyword transcribed from an audio portion of the media content or a visual object detected in a visual portion of the media content; determine a permissible use status of the media content based on a comparison of the at least one content element to usage parameters that characterize authorized uses of the person of interest in media; and output an indication of the permissible use status.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 illustrates a block diagram of an example environment in which synthetic media detection with permissible use verification algorithms may be trained and/or deployed to an end user in accordance with one or more techniques of the disclosure.

FIG. 2 is a detailed block diagram illustrating an example computing system, in accordance with one or more techniques of the disclosure.

FIG. 3 is a simplified block diagram illustrating an example of the permissible use verification system, in accordance with one or more techniques of this disclosure.

FIG. 4 is a detailed block diagram illustrating an example of the permissible use verification system, in accordance with one or more techniques of the disclosure.

FIG. 5 is a flowchart illustrating an example method for permissible use verification of synthetic media, according to one or more techniques described in this disclosure.

Like reference characters refer to like elements throughout the figures and description.

### DETAILED DESCRIPTION

Existing deepfake detection technologies primarily focus on determining the authenticity of media content by distinguishing between real and synthetic or fabricated media. While effective at identifying manipulation, current approaches often fail to address the contextual legitimacy of the content. Specifically, existing deepfake detection systems typically lack the capability to verify whether a detected deepfake constitutes an unauthorized impersonation or a sanctioned creation generated with the consent of the subject, such as for commercial endorsements or authorized entertainment. This limitation creates a significant gap in protecting the rights and reputations of Persons of Interest (POIs), as benign or contractually permitted synthetic media may remain indistinguishable from malicious exploitation under standard detection frameworks.

To address these limitations, this disclosure describes techniques for a comprehensive permissible use verification system. In operation, the disclosed system detects synthetic media associated with a specific POI and validates the content against established authorization parameters. For example, the disclosed system may employ a multi-stage process that first filters media to isolate content containing the POI using biometric recognition, then analyzes the isolated content to detect synthetic manipulation. Upon confirming the presence of a deepfake, the disclosed system triggers a permissible use verification module that cross-references audio transcripts, visual elements, and semantic contexts against a database of authorized keywords, objects, and usage agreements specific to that POI.

By integrating deepfake detection with permissible use verification, the disclosed techniques provide a robust mechanism for safeguarding POI rights while accommodating legitimate commercial applications of synthetic media. These techniques allow for the automated enforcement of usage agreements, ensuring that authorized content is distinguished from unauthorized exploitation. Consequently, the disclosed system reduces the prevalence of malicious impersonation and misinformation while preserving the brand integrity and commercial interests of the POI in an increasingly synthetic digital landscape. Furthermore, by accurately distinguishing between authorized synthetic presence and malicious exploitation, the techniques described herein improve public trust in digital media. This restoration of trust encourages legitimate commercial partnerships and protects the audience from deception, fostering a healthier digital ecosystem for both content creators and consumers.

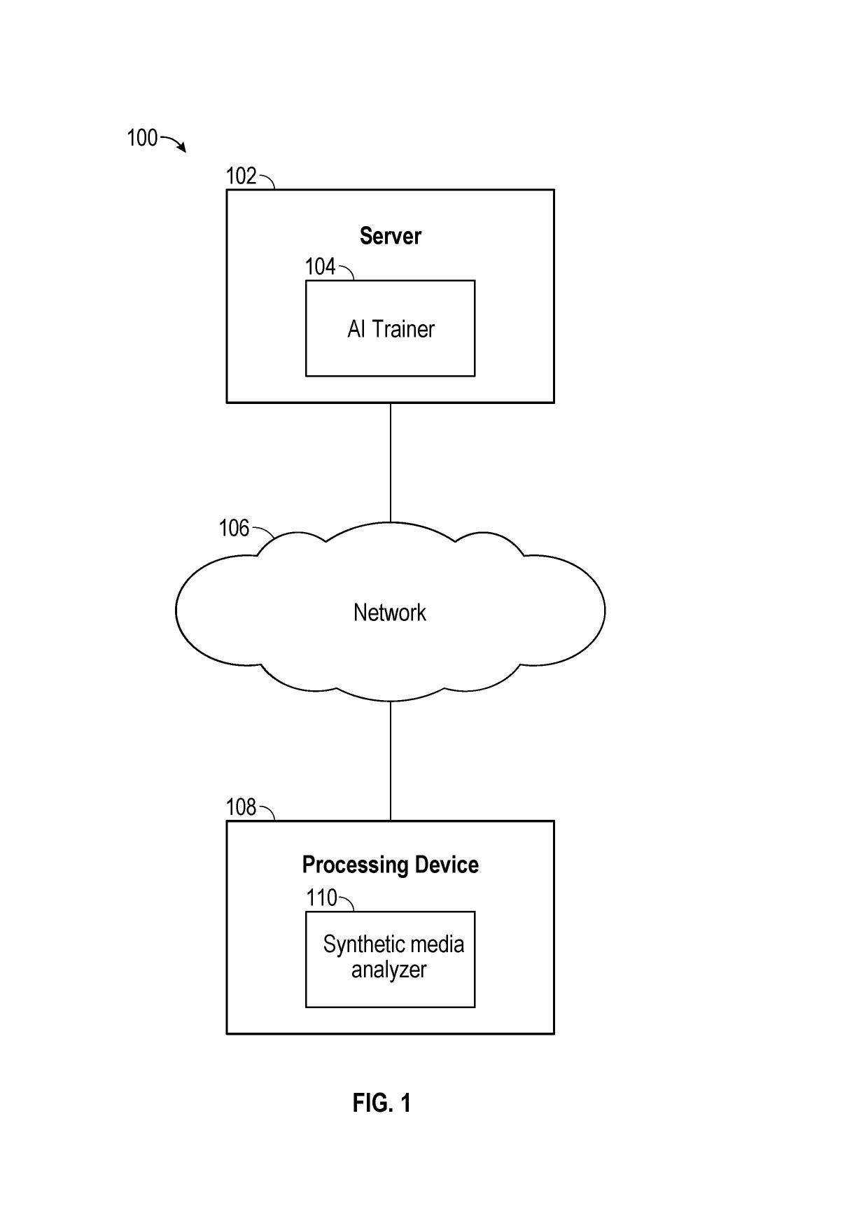

FIG. 1 illustrates a block diagram of an example environment in which synthetic media detection with permissible use verification algorithms may be trained and/or deployed to an end user in accordance with one or more techniques of the disclosure. The rapid advancement of Artificial Intelligence (AI)-driven synthetic media technologies raises significant concerns, particularly regarding unauthorized use of such technologies to falsify media. Malicious actors often create synthetic media content to impersonate POIs, such as celebrities, politicians, and influencers, to promote products without consent, spread misinformation, or create false endorsements. Conversely, certain POIs may register faces and/or voices with specific companies for fair commercial use. Such companies create synthetic media versions of the registered POIs for specific commercial purposes, representing a permissible use of the synthetic media persona. To address these challenges, the techniques of this disclosure provide a solution to safeguard rights of POIs against unauthorized exploitation through synthetic media technology while validating permissible use of the synthetic media samples. Synthetic media may include so-called “deep fakes”.

FIG. 1 illustrates a block diagram of an example environment 100 including an example server 102, an example AI trainer 104, an example network 106, an example processing device 108, and an example synthetic media analyzer 110. Although example environment 100 includes synthetic media analyzer 110 in example processing device 108, example synthetic media analyzer 110 may additionally or alternatively be implemented in example server 102. In some examples, synthetic media analyzer 110 also functions as a permissible use verification system.

Example server 102 of FIG. 1 includes example AI trainer 104. AI trainer 104 trains one or more AI models based on datasets of media associated with specific POIs. For example, AI trainer 104 may utilize media samples (audio, video, images) to train biometric recognition models (e.g., face recognition, speaker recognition) to identify specific POIs within a media stream. Furthermore, AI trainer 104 may utilize datasets of real and synthetic media to train synthetic media detection models to distinguish between authentic content and AI-generated content. In some examples, AI trainer 104 employs Large Language Models (LLMs) or Retrieval-Augmented Generation (RAG) systems to generate specific profiles or dossiers of a POI (e.g., “Taylor Swift”) to facilitate semantic analysis for permissible use verification. Additionally, AI trainer 104 may implement specialized training processes for POIs categorized as lower-profile, where publicly available training data may be limited. Lower-profile POIs include individuals who lack a substantial public data footprint or widely available online media presence. Unlike high-profile celebrities or major political figures who have vast amounts of accessible audio and visual data, lower-profile POIs have limited publicly available training data. In such instances, AI trainer 104 may generate synthetic training data to enrich and provide a comprehensive semantic profile of the specific POI. This process may involve the training and deployment of LLM adapters. These LLM adapters are trained specifically per POI to fine-tune the semantic analysis capabilities of the disclosed system without requiring retraining of the underlying foundation model. These adapter-based techniques better ensure that the permissible use verification system 200 maintains high accuracy even for individuals with smaller data footprints. AI trainer 104 may also manage authorized databases, such as permissible keyword lists or authorized visual object libraries (e.g., logos, products) defined by usage agreements. AI trainer 104 can use feedback from deployed models to tune the detection thresholds or update the authorized databases based on new contractual parameters or identified misclassifications.

In some examples, AI trainer 104 receives feedback (e.g., flagged unauthorized content, verified permissible use content, false positives) from example processing device 108 after synthetic media analyzer 110 has performed verification locally. AI trainer 104 may use the feedback to identify reasons for errors in synthetic media detection or permissible use evaluation. Additionally or alternatively, AI trainer 104 may utilize the feedback to update the POI-specific LLM adapters or keyword databases.

After example AI trainer 104 trains the models (e.g., the POI filtering model, the synthetic media detection model, and the permissible use verification logic described in greater detail below), AI trainer 104 deploys one or more models so that they can be implemented on another device (e.g., example processing device 108). For example, AI trainer 104 may deploy a set of weights for a neural network or a structured database of authorized terms. When example processing device 108 receives the deployed models and data, processing device 108 can execute the instructions to configure synthetic media analyzer 110 to monitor and verify media content locally.

Example network 106 of FIG. 1 is a system of interconnected systems exchanging data. Example network 106 may be implemented using any type of public or private network such as, but not limited to, the Internet, a telephone network, a local area network (LAN), a cable network, and/or a wireless network. To enable communication via network 106, example processing device 108 and/or server 102 includes a communication interface that enables a connection to an Ethernet, a digital subscriber line (DSL), a telephone line, a coaxial cable, or any wireless connection, etc.

Example processing device 108 of FIG. 1 is a device that receives instructions, data, and/or an executable corresponding to the deployed models. Synthetic media analyzer 110 of processing device 108 uses the instructions and data to implement the deployed models locally. Example processing device 108 of FIG. 1 is a computer. Alternatively, example processing device 108 may be a laptop, a tablet, a smart phone, a personal processor, a server, and/or any other type of processing device.

Example synthetic media analyzer 110 of FIG. 1 configures a local system to implement the permissible use verification techniques. After one or more models are implemented, synthetic media analyzer 110 monitors media content (e.g., via an active media crawler on social media platforms) to detect suspicious content. Synthetic media analyzer 110 utilizes a POI filtering module to isolate media segments containing the specific POI using, for example, face and speaker recognition. Synthetic media analyzer 110 then analyzes the filtered media using a synthetic media detection module to classify the content as real or synthetic. Upon identifying synthetic content, synthetic media analyzer 110 activates a permissible use verification module. This module may transcribe audio to cross-reference keywords against an authorized database, detect visual objects to validate commercial associations, and/or perform semantic analysis using an LLM to check for consistency with the POI's profile or permissible use definition. Example synthetic media analyzer 110 generates a report detailing the findings (e.g., “Unauthorized Deepfake,” “Permissible Commercial Use”) and transmits the report to a commercial client or AI trainer 104. In some examples, synthetic media analyzer 110 may take additional actions, such as, but not limited to, flagging the media for takedown, generating a warning indication, or notifying a rights management entity.

While the examples herein describe proposed solutions involving audio and visual (e.g., images and video) modalities, the techniques of this disclosure may also cover other modalities, such as, but not limited to, text. A challenge exists in identifying whether media content represents real or fabricated data while also determining if the media content adheres to permissible use cases. Existing commercial detection methods focus primarily on identifying synthetic media and often neglect to verify whether the content usage by commercial companies constitutes an appropriate or authorized use. Existing commercial solutions primarily analyze visual and audio components of the media to detect deepfake. Such approaches often fail to assess whether the use of synthetic media complies with permissible use provisions, leaving a significant gap in the protection of the rights and reputation of a Person of Interest (POI). Advantageously, the disclosed permissible use verification system is configured and trained to address the aforementioned limitations of existing commercial solutions.

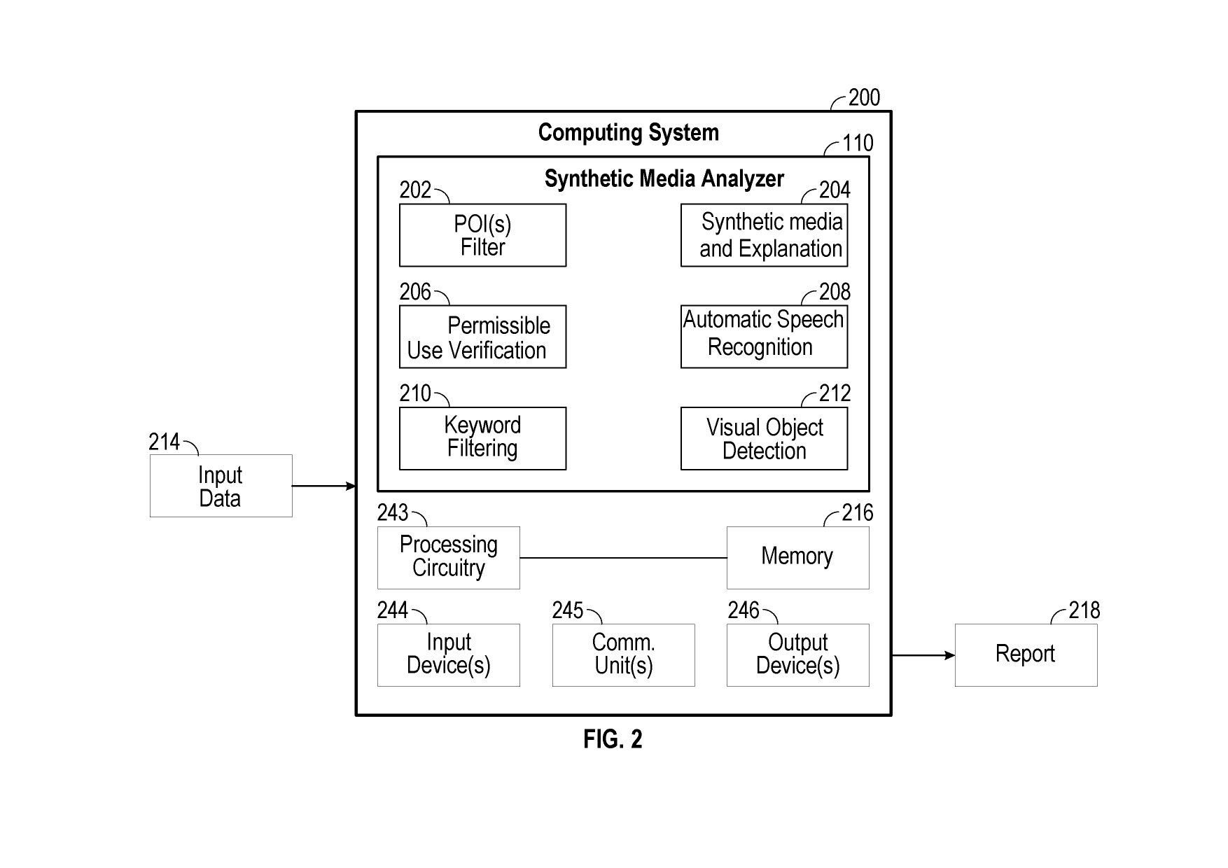

FIG. 2 is a block diagram illustrating an example computing system 200. In an aspect, computing system 200 may comprise an instance of the permissible use verification system. To perform permissible use verification and synthetic media detection, computing system 200 includes processing circuitry 243 and memory 216 for executing synthetic media analyzer 110 having POI filter module 202, synthetic media and explanation module 204, permissible use verification module 206, automatic speech recognition (ASR) module 208, keyword filtering module 210, and visual object detection module 212.

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, a server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. Computing system 200 may represent an instance of the system 100 of FIG. 1.

In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network – PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Memory 216 may comprise one or more storage devices. One or more components of computing system 200 (e.g., processing circuitry 243, memory 216) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 216 may be distributed among multiple devices.

Memory 216 may store information for processing during operation of computing system 200. In some examples, memory 216 comprises temporary memories, meaning that a primary purpose of the one or more storage devices of memory 216 is not long-term storage. Memory 216 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 216, in some examples, may also include one or more computer-readable storage media. Memory 216 may be configured to store larger amounts of information than volatile memory. Memory 216 may further be configured for long-term storage of information as non-volatile memory space and retain information after activate/off cycles. Examples of non-volatile memories include magnetic hard disks, optical discs, Flash memories, or forms of erasable programmable read-only memory (EPROM) or electrically erasable programmable read-only memory (EEPROM). Memory bmay store program instructions and/or data associated with one or more of the modules described in accordance with one or more aspects of this disclosure.

Processing circuitry 243 and memory 216 may provide an operating environment or platform for one or more modules or units (e.g., POI filter module 202, synthetic media and explanation module 204, permissible use verification module 206, ASR module 208, keyword filtering module 210, and visual object detection module 212), which may be implemented as software, but may in some examples include any combination of hardware, firmware, and software. Processing circuitry 243 may execute instructions and the one or more storage devices, e.g., memory 216, may store instructions and/or data of one or more modules. The combination of processing circuitry 243 and memory 216 may retrieve, store, and/or execute the instructions and/or data of one or more applications, modules, or software. Processing circuitry 243 and/or memory 216 may also be operably coupled to one or more other software and/or hardware components, including, but not limited to, one or more of the components illustrated in FIG. 2.

Processing circuitry 243 may execute computing system 200 using virtualization modules, such as a virtual machine or container executing on underlying hardware. One or more of such modules may execute as one or more services of an operating system or computing platform. Aspects of computing system 200 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more Universal Serial Bus (USB) interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a Global Positioning System (GPS) receiver, or any other type of device that can send and/or receive information. Other examples of communication units 245 may include Bluetooth®, GPS, 3G, 4G, 5G and Wi-Fi® radios found in mobile devices as well as Universal Serial Bus (USB) controllers and the like.

In the example of FIG. 2, synthetic media analyzer 110 may receive input data 214 and synthetic media analyzer 110 may generate report 218. Input data 214 and report 218 may contain various types of information. For example, input data 214 may include media content such as, but not limited to, online real (i.e., non-synthetic or primarily non-synthetic) and synthetic media data, which may comprise audio, video, images, or a combination thereof. Report 218 may include results of permissible use checks, verification status of deepfake content, identified violations, and context information regarding the analyzed media.

Computing system 200 may continuously monitor social media platforms and other online spaces, scanning for suspicious media content for specific POI(s) using an active media crawler, for example. Upon detecting suspicious or flagged media, computing system 200 passes the media through modules of synthetic media analyzer 110 to determine authenticity and assess compliance with permissible use policies. The process begins with POI filter module 202 receiving requests from commercial clients and processing media by identifying and isolating content related to specific POIs. POI filter module 202 may integrate speaker and face recognition algorithms to filter non-POI data, retaining segments relevant to the designated POI. Synthetic media and explanation module 204 then analyzes the filtered media segments. Synthetic media and explanation module 204 employs synthetic media detection techniques to classify the media as real or synthetic media.

Upon verification of the synthetic media content, synthetic media and explanation module 204 forwards the content to permissible use verification module 206. Permissible use verification module 206 subjects the media to comprehensive analysis and may check for permissible use of the detected synthetic media content. Permissible use verification module 206 compiles the results of this analysis into report 218 for the permissible use commercial client. Report 218 may outline whether the analyzed media complies with permissible use provisions or violates POI rights. Permissible use verification module 206 coordinates a rigorous multi-step verification process upon identifying synthetic media. As part of this process, ASR module 208 transcribes the input audio data into a structured text format.

In addition to producing a transcript, ASR module 208 extracts key phrases and generates a keyword list. Permissible use verification module 206 later cross-references the keyword list with an authorized keyword database for the specific POI. Keyword filtering module 210 scans the generated word transcripts keyword list against a pre-defined, POI-specific keyword internal database. The keyword internal database may include phrases and terms permissible based on authorized usage agreements of the POI. Keyword filtering module 210 flags keyword discrepancies or unauthorized phrases. Keyword filtering module 210 includes the flagged discrepancies or unauthorized phrases for further examination. Visual object detection module 212 subjects the visual content within the media to object detection. Visual object detection module 212 identifies visual elements (e.g., logos, products, landmarks). Visual object detection module 212 cross-checks the identified visual elements against the authorized POI-specific visual object database.

Furthermore, permissible use verification module 206 may be configured to perform a damage assessment on content identified as unauthorized. Regardless of the strict permissible use status, permissible use verification module 206 analyzes the semantic context of the media to determine if the content is damaging to the reputation of the POI or if it constitutes a benign use, such as a harmless advertisement or parody. This secondary layer of analysis allows report 218 to distinguish between malicious exploitation requiring immediate enforcement and benign unauthorized use that may not warrant aggressive takedown actions.

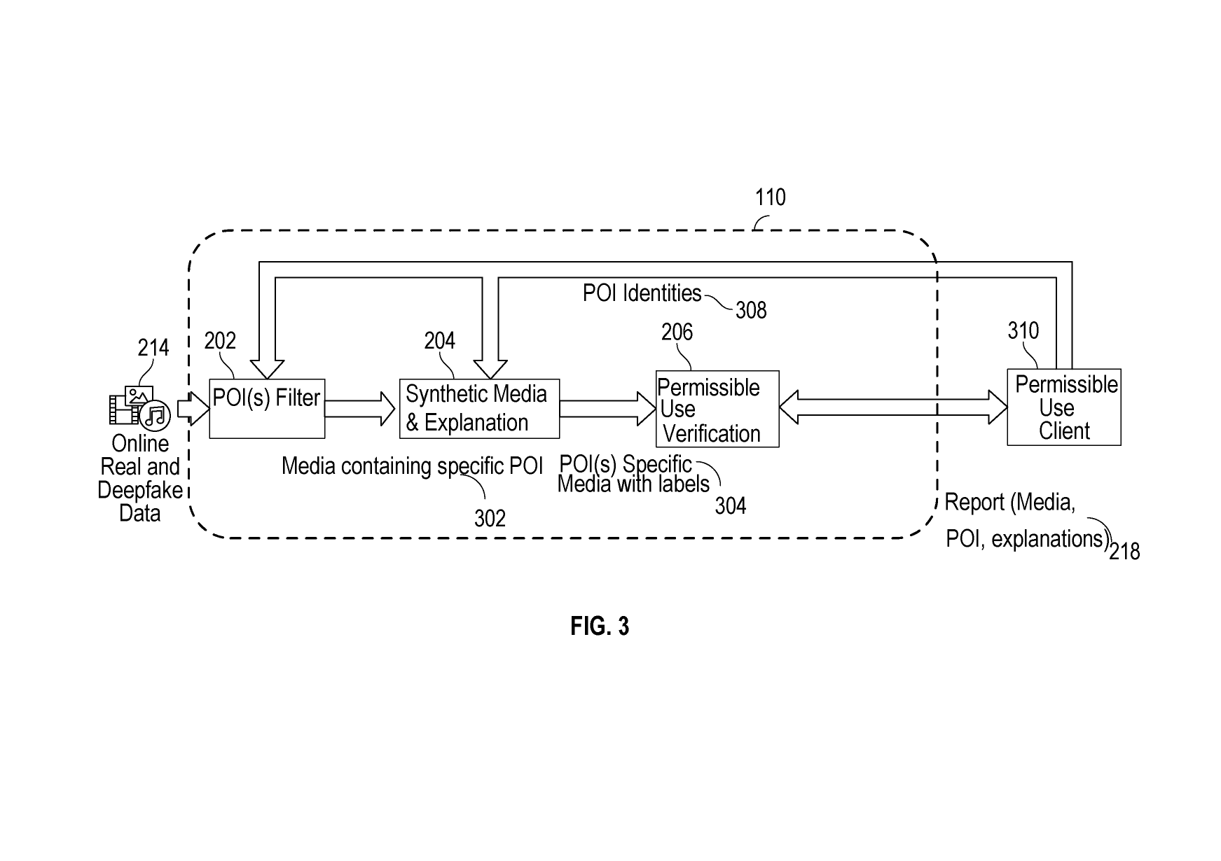

FIG. 3 is a simplified block diagram illustrating an example of the permissible use verification system, in accordance with one or more techniques of this disclosure. The process begins with input data 214 (e.g., online real and synthetic media data) entering POI filter module 202. In some examples, POI filter module 202 may receive requests from commercial clients providing input data 214. POI filter module 202 processes input data 214 by identifying and isolating content related to specific POIs. POI filter module 202 may integrate speaker and face recognition algorithms to filter non-POI data, retaining only the segments relevant to the designated POI.

Synthetic media and explanation module 204 functions as a diagnostic engine that classifies media content and generates interpretability data explaining the classification. POI filter module 202 and synthetic media and explanation module 204 utilize POI identities 308 to perform filtering and targeted analysis. POI identities 308 may include, but are not limited to, a list of client POI(s). POI filter module 202 may detect media data for permissible use verification. POI filter module 202 outputs only media containing specific POI(s) 302 to synthetic media and explanation module 204. Synthetic media and explanation module 204 employs synthetic media detection techniques to classify the received media as real or synthetic media. Synthetic media and explanation module 204 generates an explanation comprising a transparency metric, such as a heat map identifying manipulated pixels or a temporal log of synthetic audio segments. In some examples, the synthetic media detection techniques employed by synthetic media and explanation module 204 include phonetically aware speaker-targeted synthetic speech detection. This technique analyzes the audio components of the media to identify inconsistencies in phonetic articulation that are characteristic of synthetic speech manipulation. By focusing on phonetic anomalies specific to the target speaker, synthetic media and explanation module 204 can distinguish between authentic recordings and high-quality voice clones that might otherwise pass standard audio analysis. Synthetic media and explanation module 204 forwards verified synthetic media content, shown as POI specific media with label 304, along with the generated explanation, to permissible use verification module 206.

Permissible use verification module 206 performs comprehensive analysis on POI specific media with labels 304. In some examples, permissible use verification module 206 executes a rigorous multi-step verification process upon identifying synthetic media. This process may include, but is not limited to, word transcription, keyword filtering, and visual object detection.

In some examples, permissible use verification module 206 generates a keyword list from a structured text format derived from the input audio. Permissible use verification module 206 determines the permissible use status by cross-referencing the keyword list with authorized keyword database 404 associated with the specific POI. Authorized keyword database 404 includes one or more keywords included for association with the person of interest (e.g., authorized brand names or slogans) or one or more keywords excluded from association with the person of interest (e.g., prohibited political terms or competitor brands).

The keyword internal database may include phrases and terms permissible based on authorized usage agreements of the POI. Permissible use verification module 206 may flag any keyword discrepancies or unauthorized phrases.

For visual object detection, permissible use verification module 206 cross-checks the visual elements against usage parameters that characterize authorized uses of the POI. Permissible use verification module 206 identifies visual elements including logos, products, product types or landmarks. In some examples, permissible use verification module 206 cross-checks identified visual elements against an authorized POI-specific visual object database 408. In other examples, such as for journalistic use cases or lower-profile POIs, processing circuitry 243 specifies the usage parameters by providing a profile or dossier for the POI as a RAG input or an LLM adapter. This profile or dossier may comprise a model of the POI developed from past public disclosures or a summary of authorized media types. Permissible use verification module 206 may flag objects that do not align with the expected set of visual identifiers.

Permissible use verification module 206 analyzes results from word transcription, keyword filtering, and visual object detection to generate report 218. Report 218 details identified violations, including unauthorized speech content, mismatched keywords, or unapproved visual elements. In some examples, permissible use verification module 206 sends report 218 (containing, for example, media and context info) to permissible use commercial client 310 for further review. This process better ensures comprehensive protection against misuse of POI synthetic media data.

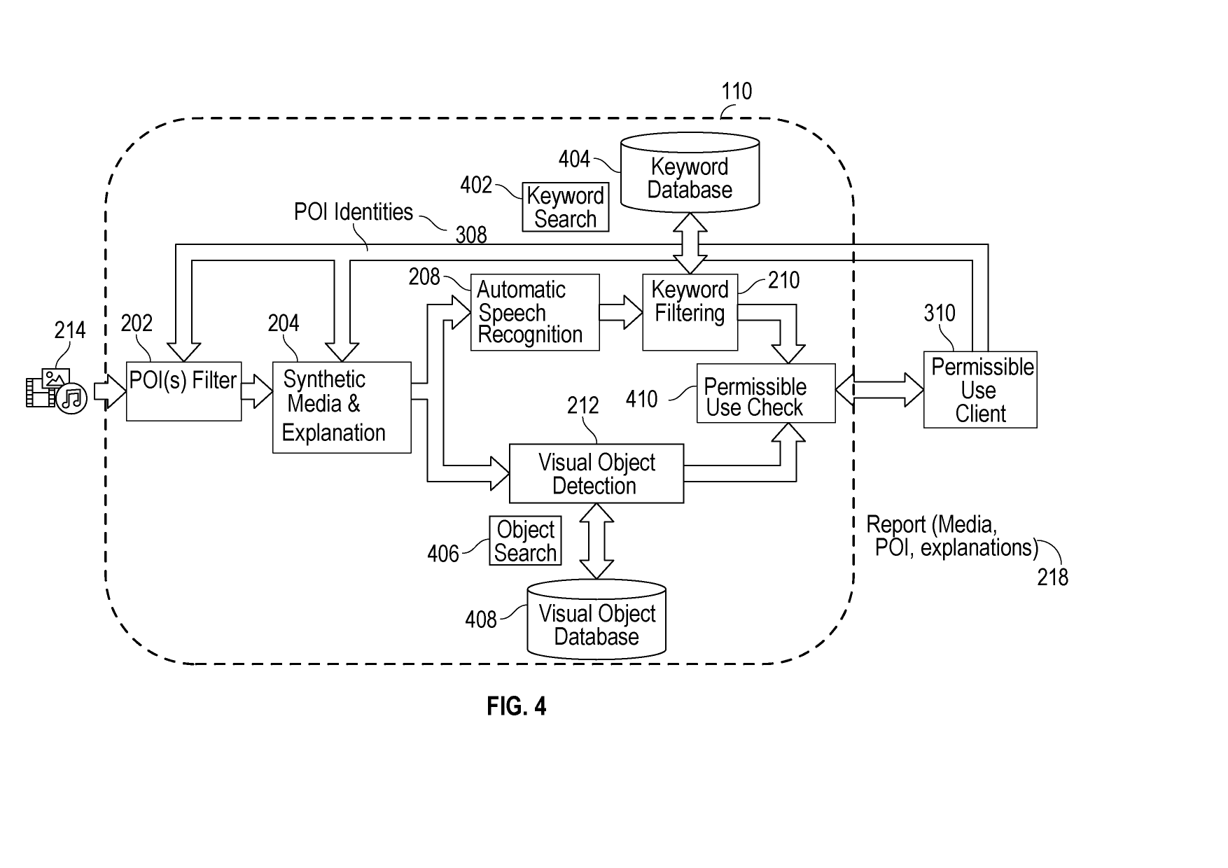

FIG. 4 is a detailed block diagram illustrating an example of the permissible use verification system, in accordance with one or more techniques of the disclosure. Unlike existing approaches that focus primarily on detecting synthetic media, the permissible use verification system, in addition to identifying synthetic media, facilitates compliance with permissible use cases. This combination of synthetic media detection and permissible use verification addresses a gap in conventional approaches. Permissible use verification module 206 extends beyond single modality detection methods by analyzing visual, audio, and textual content of media. Permissible use verification module 206 cross-references detected keywords, objects, and speakers with pre-authorized databases, such as keyword database 404 and visual object database 408, containing commercially permitted uses.

In some examples, the permissible use verification system (shown as computing system 200 in FIG. 2) represents a detailed view of the interaction between various components within synthetic media analyzer 110. In the illustrated example, the permissible use verification system includes a POI filter module 202, a synthetic media and explanation module 204, and a set of verification sub-modules configured to validate permissible use.

As shown in FIG. 4, POI filter module 202 receives input data 214, which may comprise online real and synthetic media data (e.g., video, audio, and/or images). POI filter module 202 identifies and isolates content comprising a representation of a specific Person Of Interest (POI) by utilizing POI identities 308. For example, POI filter module 202 may employ face recognition and speaker recognition algorithms to discard non-relevant segments and output filtered media to synthetic media and explanation module 204. A representation of a POI refers to any machine-perceivable audio, video, or image-based depiction or rendering in media content that uniquely identifies, symbolizes, and/or represents the POI within the media content. A representation encompasses both photorealistic or audio captures and synthesized abstractions. A representation may be associated with a set of extracted biometric features, a digital mesh mapped to anatomical coordinates, or a latent space vector derived from a neural network trained on human physiological characteristics. A representation may include non-image-based identifiers, such as unique vocal signatures or behavioral metadata, that allow a computing system to distinguish a specific individual’s presence or actions within media content.

Synthetic media and explanation module 204 analyzes the filtered media to classify the content as real or synthetic. Upon detecting synthetic content (e.g., a deepfake), synthetic media and explanation module 204 forwards the corresponding media to the verification subsystems for multi-modal analysis.

The verification process involves parallel or sequential analysis of audio and visual components. For the audio component, automatic speech recognition (ASR) module 208 converts spoken audio from the synthetic media into a structured text format. ASR module 208 extracts key phrases and generates a keyword list. A keyword filtering module 210 receives the keyword list and performs a keyword search 402 against a keyword database 404. In some examples, keyword database 404 stores authorized terms, phrases, and permissible contexts defined by usage agreements associated with the POI. Keyword filtering module 210 identifies discrepancies between the spoken content and the authorized terms stored in keyword database 404.

Simultaneously, for the visual component, a visual object detection module 212 analyzes visual frames of the synthetic media. Visual object detection module 212 performs an object search 406 to identify visual elements such as, but not limited to, logos, products, product types, or landmarks. Visual object detection module 212 queries a visual object database 408 to determine if the detected objects are authorized for association with the POI. In some examples, visual object database 408 contains a repository of approved visual assets (e.g., commercial products the POI is contracted to endorse).

Visual object detection module 212 may flag objects that do not align with the expected set of visual identifiers. Permissible use verification module 206 may perform permissible use check 410 in which permissible use verification module 206 may analyze results from ASR module 208, keyword filtering module 210, and visual object detection module 212. Permissible use verification module 206 generates report 218 as a comprehensive report. In some examples, report 218 details identified violations, including unauthorized speech content, mismatched keywords, or unapproved visual elements. As a non-limiting example, report 218 may include an ad featuring a famous actor selling impermissible product types, such as, but not limited to, drugs, guns, and the like. Permissible use verification module 206 sends report 218 to permissible use commercial client 310 for further review, ensuring comprehensive protection against misuse.

In some examples, permissible use check 410 incorporates a Large Language Model (LLM) or a Retrieval-Augmented Generation (RAG) system to perform a semantic analysis. To facilitate the determination of the permissible use status, permissible use check 410 defines the usage parameters as a semantic profile or dossier of the person of interest (e.g., a “Taylor Swift” model). Processing circuitry 243 performs a comparison of the synthetic media content against the usage parameters to determine whether a context of the synthetic media content aligns with the established persona or permissible use policy of the person of interest. For example, processing circuitry 243 may utilize the LLM to assess semantic similarity between the synthetic media content and the dossier. For a lower-profile person of interest, processing circuitry 243 may generate the usage parameters by creating synthetic training data to enrich the semantic profile or by training an LLM adapter specific to the person of interest. In another example, or in parallel with the LLM-based analysis, processing circuitry 243 specifies permissible uses by providing a profile or dossier for the person of interest as a RAG input to permissible use check 410. This profile or dossier directly specifies in text the types of media content authorized by the person of interest, such as authorizing only sports commercials or music commercials. This technique allows for the direct inclusion of enough information about a specific person of interest, such as Taylor Swift, to develop a model of the person of interest for comparison. The LLM-based analysis captures visual and language semantics that keyword matching might miss.

As part of permissible use check 410, permissible use verification module 206 generates a final report 218 detailing the findings. Report 218 may include, but is not limited to, media clips, context information, and specific flags for unauthorized speech or unapproved visual associations. In one example, report 218 identifies a violation where a representation of a POI, such as Taylor Swift, appears in synthetic media associated with unapproved products including pharmaceuticals or weapons. The permissible use verification system transmits report 218 to a permissible use commercial client 310. In some examples, if permissible use check 410 determines the usage is unauthorized and malicious, the permissible use verification system triggers an automated enforcement action, such as, but not limited to, a takedown request.

The permissible use verification system significantly enhances protection for a POI against unauthorized synthetic media usage. By validating content against authorized databases, the permissible use verification system facilitates compliance with permissible use cases. Consequently, the permissible use verification system provides better control over misuse of synthetic media and prevents commercial exploitation. Additionally, the techniques described herein reduce dissemination of misinformation.

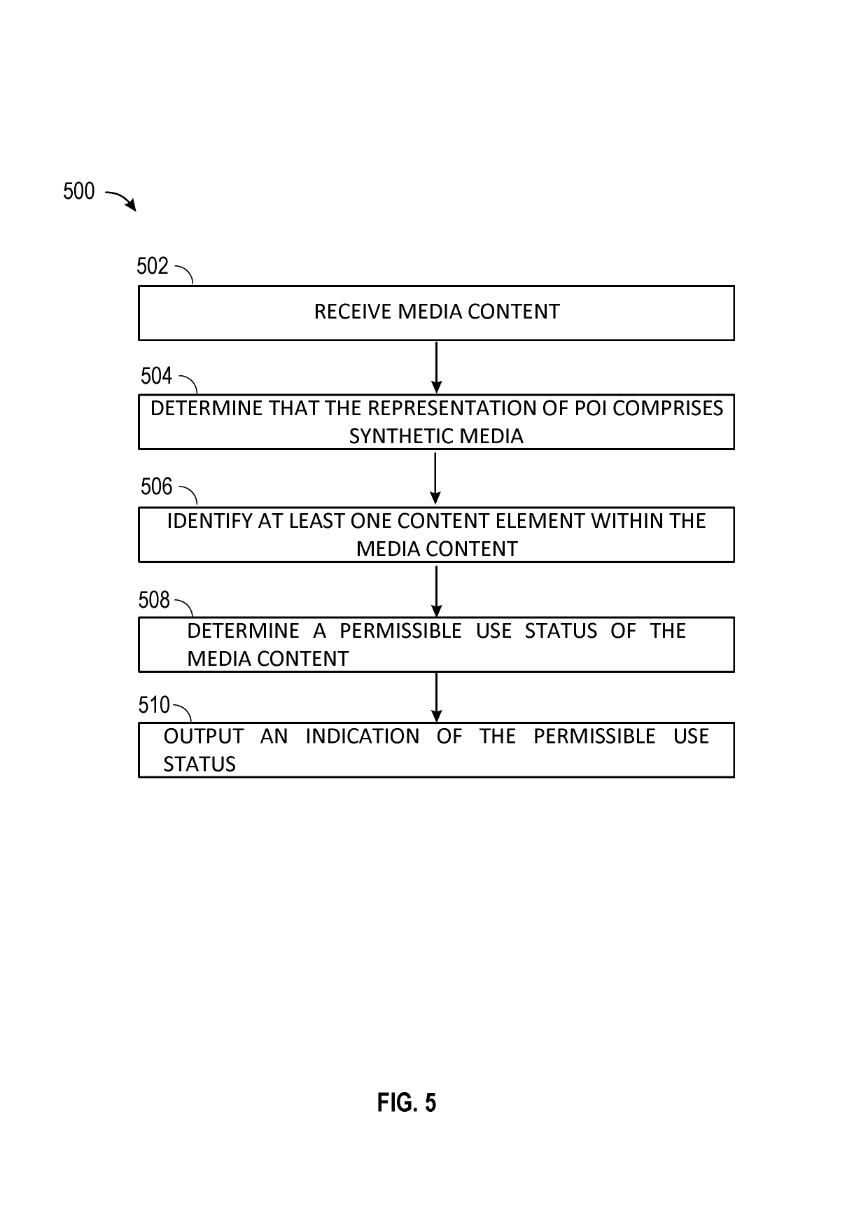

FIG. 5 is a flowchart illustrating an example method for permissible use verification of synthetic media, according to one or more techniques described in this disclosure. Processing circuitry 243 may execute method 500. Processing circuitry 243 receives media content comprising a representation of a person of interest (502). In some examples, processing circuitry 243 isolates a content segment related to the person of interest by filtering non-relevant data. In some examples, processing circuitry 243 may apply a speaker recognition algorithm or a face recognition algorithm to the media content to perform this isolation.

Processing circuitry 243 determines that the representation of the person of interest comprises synthetic media (504). Processing circuitry 243 employs synthetic media detection techniques to classify the media as real or synthetic media. Upon classifying the content as synthetic, processing circuitry 243 identifies at least one content element within the media content (506). The at least one content element includes at least one of a keyword transcribed from an audio portion of the media content or a visual object detected in a visual portion of the media content. To identify the keyword, processing circuitry 243 transcribes an input audio of the media content into a structured text format. To identify the visual object, processing circuitry 243 detects a visual element, such as a logo, a product, or a landmark, in the media content.

Processing circuitry 243 determines a permissible use status of the media content based on a comparison of the at least one content element to usage parameters that characterize authorized uses of the person of interest in media (508). The permissible use status indicates whether the representation of the person of interest constitutes an authorized exploitation or an unauthorized infringement. For example, the permissible use status may be categorized as “authorized commercial use” (e.g., a compliant advertisement), “unauthorized malicious deepfake” (e.g., a non-consensual political endorsement), or “benign unauthorized use” (e.g., a parody or fan creation that does not violate damaging thresholds). The usage parameters define criteria for permissible exploitation of the identity of the person of interest, such as rules derived from commercial contracts, consent agreements, or brand guidelines. For example, the usage parameters may include a list of authorized brand associations (e.g., specific logos or products), approved script topics, temporal limitations on usage, or prohibited contexts (e.g., political endorsements or hate speech). For example, processing circuitry 243 cross-references a keyword list generated from the structured text format with authorized keyword database 404. Additionally or alternatively, processing circuitry 243 determines the permissible use status by cross-checking the detected visual element against authorized visual object database 408 associated with the person of interest. Authorized visual object database 408 includes one or more visual elements included for association with the person of interest (e.g., approved sponsor products) or one or more visual elements excluded from association with the person of interest (e.g., banned iconography or competitor logos). In some examples, processing circuitry 243 generates a profile of the person of interest using a Large Language Model (LLM) based on training data associated with the person of interest to aid in the determination.

Processing circuitry 243 outputs an indication of the permissible use status (510). In some examples, processing circuitry 243 generates a report comprising description of an identified violation including at least one of unauthorized speech content, a mismatched keyword, or an unapproved visual element. Processing circuitry 243 transmits the report to permissible use commercial client 310 for review. In some examples, to facilitate internet scouting, permissible use verification system 200 may utilize an intermediary scouting entity. The intermediary scouting entity maintains established service agreements with social media platforms to enable high-volume media access. This intermediary scouting entity may employ specific API protocols to obtain media content in a cost-effective and computationally efficient manner. Processing circuitry 243 authenticates with the intermediary scouting entity or directly with social media platforms using secure token-based protocols. In some examples, processing circuitry 243 executes decision logic to determine whether to generate a report for manual review or initiate an automated enforcement action. Processing circuitry 243 categorizes violations based on severity levels defined by the POI. For extreme violations, such as media content containing nudity, weapons, violence, or controlled substances, permissible use verification system 200 automatically initiates an enforcement action. The automated enforcement action includes generating a Digital Millennium Copyright Act (DMCA) notice and transmitting the DMCA notice to a content provider via an API to cause an automated takedown of the media content. For milder violations, such as unauthorized commercial use to sell unapproved products, processing circuitry 243 generates a report for permissible use commercial client 310 without initiating a takedown. This reporting allows the POI or a managing entity to pursue potential revenue streams from the unauthorized usage. In another scenario, permissible use verification system 200 performs only reporting and delegates the distinction between enforcement and monetization to a commercial entity managing the permissible use cases for the POI.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer-readable storage media may include random access memory (RAM), read only memory (ROM), programmable read only memory (PROM), erasable programmable read only memory (EPROM), electronically erasable programmable read only memory (EEPROM), flash memory, a hard disk, a Compact Disk Read-Only Memory (CD-ROM), a floppy disk, a cassette, magnetic media, optical media, or other computer readable media.

Where a phrase similar to “at least one of A, B, and C” is used in the claims, it is intended that the phrase be interpreted to mean that A alone may be present in an embodiment; B alone may be present in an embodiment; C alone may be present in an embodiment; or that any combination of the elements A, B, and C may be present in a single embodiment, for example, A and B, A and C, B and C, or A and B and C.

Where a phrase similar to “one or more processors configured to X, Y, and Z” is used in the claims, it is intended that the phrase be interpreted to mean at least: that a processor A alone may perform functions X, Y, and Z; that two or more processors (e.g., processors A and B) may collectively perform functions X, Y, and Z; that a first processor A may perform functions X and Y and a second processor may perform function Z; or that a first processor A may perform function X, a second processor may perform function Y, and a third processor may perform function Z.

What is claimed is:

1. A method for synthetic media detection and use verification, the method comprising:
receiving media content comprising a representation of a person of interest;
determining that the representation of the person of interest comprises synthetic media;
identifying at least one content element within the media content, wherein the at least one content element includes at least one of: a keyword transcribed from an audio portion of the media content or a visual object detected in a visual portion of the media content;
determining a permissible use status of the media content based on a comparison of the at least one content element to usage parameters that characterize authorized uses of the person of interest in media; and
outputting an indication of the permissible use status.

2. The method of claim 1, further comprising:
isolating a content segment related to the person of interest by filtering data from the media content that does not relate to usage of the representation of the person of interest.

3. The method of claim 2, wherein isolating the content segment comprises applying at least one of a spoken speaker recognition algorithm or a face recognition algorithm to the media content to exclude data that does not include a representation of the person of interest.

4. The method of claim 1, wherein identifying the at least one content element comprises transcribing the audio portion of the media content into a structured text format.

5. The method of claim 4, wherein determining the permissible use status comprises cross-referencing a keyword list generated from the structured text format with an authorized keyword database that includes one or more keywords included for association with the person of interest or excluded from association with the person of interest.

6. The method of claim 1, wherein identifying the at least one content element comprises detecting a visual element including at least one of a logo, a product, a product type, or a landmark in the media content.

7. The method of claim 6, wherein determining the permissible use status comprises cross-checking the detected visual element against an authorized visual object database associated with the person of interest that includes one or more visual elements included for association with the person of interest or excluded from association with the person of interest.

8. The method of claim 1, wherein outputting the indication comprises generating a report comprising description of an identified violation including at least one of unauthorized speech content, a mismatched keyword, or an unapproved visual element.

9. The method of claim 1, further comprising:
generating a profile of the person of interest using a Large Language Model (LLM) based on training data associated with the person of interest, and wherein determining the permissible use status is further comprising determining the permissible use status based on a semantic analysis performed using the LLM.

10. The method of claim 8, further comprising:
initiating an automated enforcement action based on the report indicating the permissible use status.

11. A computing system for synthetic media detection and use verification, the computing system comprising:
at least one memory; and
processing circuitry in communication with the at least one memory, the processing circuitry configured to:
receive media content comprising a representation of a person of interest;
determine that the representation of the person of interest comprises synthetic media;
identify at least one content element within the media content, wherein the at least one content element includes at least one of: a keyword transcribed from an audio portion of the media content or a visual object detected in a visual portion of the media content;
determine a permissible use status of the media content based on a comparison of the at least one content element to usage parameters that characterize authorized uses of the person of interest in media; and
output an indication of the permissible use status.

12. The computing system of claim 11, wherein the processing circuitry is further configured to:
isolate a content segment related to the person of interest by filtering data from the media content that does not relate to usage of the representation of the person of interest.

13. The computing system of claim 12, wherein to isolate the content segment, the processing circuitry is further configured to apply at least one of a spoken speaker recognition algorithm or a face recognition algorithm to the media content to exclude data that does not include a representation of the person of interest.

14. The computing system of claim 11, wherein to identify the at least one content element, the processing circuitry is further configured to transcribe the audio portion of the media content into a structured text format.

15. The computing system of claim 14, wherein to determine the permissible use status, the processing circuitry is further configured to cross-reference a keyword list generated from the structured text format with an authorized keyword database that includes one or more keywords included for association with the person of interest or excluded from association with the person of interest.

16. The computing system of claim 11, wherein to identify the at least one content element, the processing circuitry is further configured to detect a visual element including at least one of a logo, a product, a product type, or a landmark in the media content.

17. The computing system of claim 16, wherein to determine the permissible use status, the processing circuitry is further configured to cross-check the detected visual element against an authorized visual object database associated with the person of interest that includes one or more visual elements included for association with the person of interest or excluded from association with the person of interest.

18. The computing system of claim 11, wherein to output the indication, the processing circuitry is further configured to generate a report comprising the representation of the person of interest, description of an identified violation including at least one of unauthorized speech content, a mismatched keyword, or an unapproved visual element.

19. The computing system of claim 11, wherein the processing circuitry is further configured to generate a profile of the person of interest using a Large Language Model (LLM) based on training data associated with the person of interest, and wherein the processing circuitry configured to determine the permissible use status is further configured to determine the permissible use status based on a semantic analysis performed using the LLM.

20. The computing system of claim 18, wherein the processing circuitry is further configured to:
initiate an automated enforcement action based on the report indicating the permissible use status.

21. A non-transitory computer-readable medium storing instructions that, when executed by processing circuitry, cause the processing circuitry to:
receive media content comprising a representation of a person of interest;
determine that the representation of the person of interest comprises synthetic media;
identify at least one content element within the media content, wherein the at least one content element includes at least one of: a keyword transcribed from an audio portion of the media content or a visual object detected in a visual portion of the media content;
determine a permissible use status of the media content based on a comparison of the at least one content element to usage parameters that characterize authorized uses of the person of interest in media; and
output an indication of the permissible use status.
